(19) United States
(12) Patent Application Publication
(10) Pub. No.: US 2025/0137233 A1
(43) Pub. Date: May 1, 2025

(54) Working Vehicle Operation Control System

(71) Applicant: TAKEUCHI MFG. CO., LTD., Hanishina-gun (JP)

(72) Inventors: Kazuhiro MIYABARA, Sakaki-machi (JP); Shingo TAKEUCHI, Sakaki-machi (JP); Yutaro YAMAZAKI, Sakaki-machi (JP)

(21) Appl. No.: 18/820,470

(22) Filed: Aug. 30, 2024

(30) Foreign Application Priority Data
Oct. 30, 2023 (JP) 2023-185276

(51) Int. Cl. E02F 9/22

(52) U.S. Cl. CPC E02F 9/2253

(57) ABSTRACT

Provided is a working vehicle operation control system that can suppress wear of a crawler. A working vehicle operation control system includes: a hydraulic pump that is driven by an engine; left and right hydraulic motors; and a hydraulic pump control unit that controls a pressurized oil discharge amount of the hydraulic pump after an engine starts, and controls a traveling operation of a working vehicle. The hydraulic pump control unit controls, in a case where one of a right-side crawler traveling speed and a left-side crawler traveling speed of the crawler is not more than a predetermined traveling reference speed and the other of the right-side crawler traveling speed and the left-side crawler traveling speed is not less than the predetermined traveling reference speed, the pressurized oil discharge amount of the hydraulic pump so as to decrease the other crawler traveling speed.

### CROSS REFERENCE TO RELATED APPLICATIONS

This application claims priority to Japanese Patent Application No. 2023-185276, filed on Oct. 30, 2023, which is expressly incorporated herein by reference in its entirety.

### BACKGROUND

### Technical Field

The present invention relates to a working vehicle operation control system.

### Related Art

Among working vehicles such as a construction machine, there has been known a working machine that uses a hydro-static transmission (HST) that includes a hydraulic pump and a hydraulic motor for enabling traveling of the working vehicle (see JP-A-2020-38002). In the working vehicle that uses the HST, operations (traveling, turning and the like) of the vehicle are controlled in response to an operation state.

In a working machine such as a construction vehicle, when the vehicle is advancing, the vehicle impinges on and breaks into soil and sands or a rock, for example, or, a crawler gets stuck in sands, mud or muddy soil so that slipping of a crawler occurs due to a sudden change of a load generated by such an action and an inertial force of the vehicle. When slipping occurs, an operation has been practiced such that a rotational speed of a traveling hydraulic motor is lowered in a state where a rotational speed of an engine is held constant.

However, a rotational speed of the traveling hydraulic motor is controlled after slipping is detected. Accordingly, for example, in a case where the crawler slips with getting stuck into soil and sands during traveling of the working vehicle, there may be a case where, to release slipping, an operator (a worker) increases or decreases operation quantity of a remote control lever for controlling the traveling hydraulic motor for increasing or decreasing a rotational speed of the traveling hydraulic motor. However, there arises a drawback that the crawler wears due to the operation of the remote control lever by the operator.

The present invention has been made in view of such circumstances, and it is an object of the present invention to provide a working vehicle operation control system that can suppress wear of a crawler.

### SUMMARY

(1) A working vehicle operation control system according to an aspect of the present invention includes a hydraulic pump, left and right hydraulic motors, and a hydraulic pump control unit, and controls a traveling operation of a working vehicle. The hydraulic pump is driven by an engine. Both left and right hydraulic motors drive crawlers on left and right sides respectively independently by making use of a pressurized oil discharged from the hydraulic pump. The hydraulic pump control unit controls a pressurized oil discharge amount of the hydraulic pump after the engine starts. The hydraulic pump control unit controls, in a case where one of a right-side crawler traveling speed and a left-side crawler traveling speed of the crawler is not more than a predetermined traveling reference speed and the other of the right-side crawler traveling speed and the left-side crawler traveling speed is not less than the predetermined traveling reference speed, the pressurized oil discharge amount of the hydraulic pump so as to decrease the other crawler traveling speed. Accordingly, in a case where either one of the crawler on the left side or the crawler on the right side slips, it is possible to suppress wear of the slipped crawler.

(2) In the working vehicle operation control system according to the aspect of the present invention, it is preferable that the hydraulic pump control unit control a pressurized oil discharge amount such that a left-side crawler traveling speed is decreased in a case where a predetermined condition is satisfied. The predetermined condition is that the right-side crawler traveling speed is not more than a right-side traveling reference speed, and the left-side crawler traveling speed not less than a left-side traveling reference speed that is larger than the right-side traveling reference speed. With such a control, in a case where the left-side crawler slips, it is possible to suppress wear of the left-side crawler.

(3) In the working vehicle operation control system according to the aspect of the present invention, it is preferable that the hydraulic pump control unit control a pressurized oil discharge amount such that a left-side crawler traveling speed is decreased in a case where a predetermined condition is satisfied. The predetermined condition is that the left-side crawler traveling speed of the crawler is not more than a left-side traveling reference speed, and the right-side crawler traveling speed is not less than a right-side traveling reference speed that is larger than the left-side traveling reference speed. With such a control, in a case where the right-side crawler slips, it is possible to suppress wear of the right-side crawler.

(4) The working vehicle operation control system according to the aspect of the present invention includes a display unit having an information inputting function. The hydraulic pump control unit determines whether or not a traveling operation restricting function is selected via the display unit. The hydraulic pump control unit determines whether or not an operating lever is tilted at least frontward by not less than a predetermined tilting amount. The hydraulic pump control unit controls the pressurized oil discharge amount of the hydraulic pump so as to decrease a traveling speed of the crawler that is a traveling operation limiting object in a case where the traveling operation limiting function is selected and is determined that an operating lever is operated forward by not less than a predetermined tilting amount.

### Advantageous Effects of the Invention

The working vehicle operation control system of the present invention detects the traveling speeds of the left and right crawlers, detects slipping of the crawler based on the detected traveling speeds of the left and right crawlers, and decreases the traveling speed of the slipped crawler. Accordingly, wear of the slipped crawler can be suppressed.

### BRIEF DESCRIPTION OF THE DRAWINGS

FIG. 1 is a perspective view of a working vehicle on which a working vehicle operation control system according to an embodiment is mounted as viewed from an oblique front side.

FIG. 2 is a block diagram illustrating the configuration of the working vehicle operation control system according to the embodiment.

FIG. 3 is a block diagram illustrating the configuration of the hydraulic pump control unit.

FIG. 4 is flowchart illustrating working vehicle operation control processing performed by the hydraulic pump control unit.

FIGS. 5(a)-5(c) are schematic views illustrating steps ranging from the detection of slipping to the release of traveling operation limiting processing. FIG. 5(a) is a view illustrating a state where a left crawler is slipped when a working vehicle travels straight forward and an operating lever is fully operated, FIG. 5(b) is a view illustrating a state where a traveling operation is limited, and FIG. 5(c) is a view illustrating a state where traveling operation limiting processing is released.

### DETAILED DESCRIPTION

In the description made hereinafter, in a case where the reference is made with respect to “up”, “down”, “left” and “right”, assume a side of a bottom surface of a working vehicle 10 as “down”, a side opposite to the bottom surface as “up”, a side of a left side surface of the working vehicle 10 when the working vehicle 10 is viewed from a rear surface as “left”, and assume a side of a right surface when the working vehicle 10 is viewed from the rear surface as “right”.

### [Configuration of Working Vehicle]

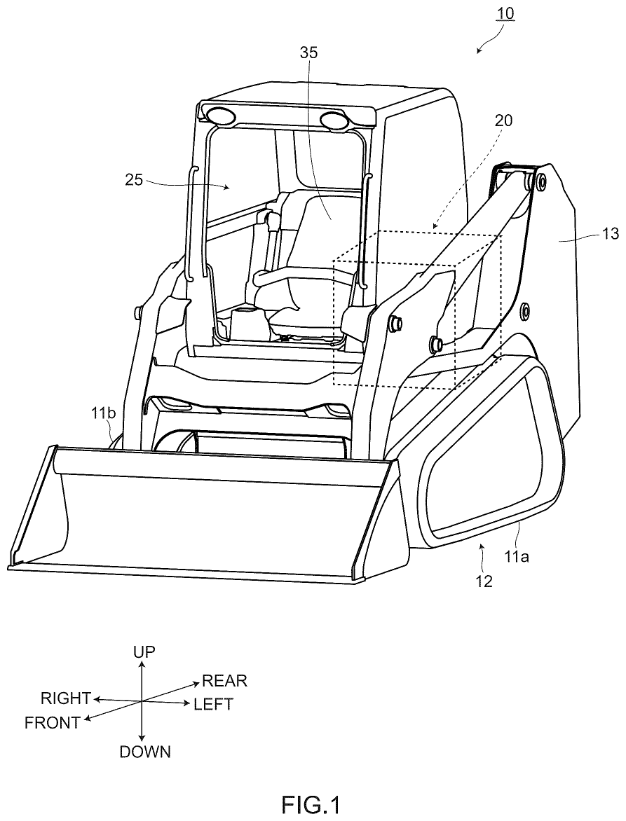

Hereinafter, an embodiment of the present invention is described with reference to drawings. In a working vehicle operation control system 1 according to the embodiment, the description is made by taking a crawler-type skid steer loader where a bucket is mounted on a distal end of an arm as an example of the working vehicle. FIG. 1 is a perspective view of a working vehicle on which a working vehicle operation control system according to an embodiment is mounted as viewed from an oblique front side. Further, the external configuration of the working vehicle 10 according to the embodiment does not constitute the gist of the present invention and hence, the external configuration is only schematically described.

As illustrated in FIG. 1, the working vehicle 10 includes: a body frame 13 on which a traveling device 12 and the like are mounted; and a cabin 25 mounted on a center upper portion of the body frame 13. The traveling device 12 includes: left and right endless crawlers (hereinafter referred to as “crawlers”) 11a, 11b, a hydraulic pump 30 and a hydraulic motor 40. The working vehicle 10 includes: the body frame 13 where the traveling devices 12 are mounted on left and right sides thereof; and a cabin 25 that is mounted on a center upper portion of the body frame 13. The cabin 25 is formed in a box shape, and an operator seat 35 on which an operator is seated in a posture that an operator faces a front side of the vehicle. With respect to the working vehicle 10, when an operator sits on the operator seat 35 and operates an operating lever, the traveling device 12 is driven so that the operator can perform traveling movement of the working vehicle 10 in response to the operation of the operating lever.

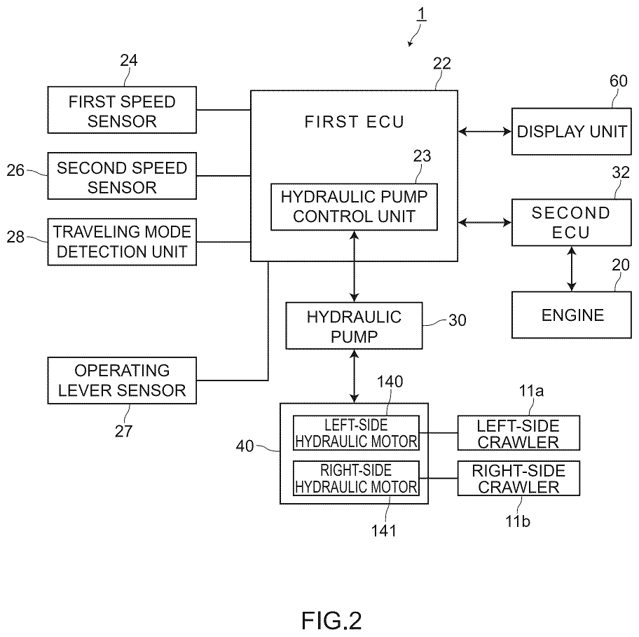

Further, an engine 20 is mounted on the working vehicle 10 at a position behind the cabin 25. The engine 20 is covered by a left-and-right body frame 13. On an inner side of the left-and-right body frame 13, a first electronic control unit (a vehicle ECU 22 (see FIG. 2) that functions as a control unit for controlling comprehensively the hydraulic pump 30 (see FIG. 2), a display unit 60 and the like, a second electronic control unit 32 (an engine ECU) that controls the engine 20, and a battery (not illustrated in the drawing) are disposed. The first ECU 22 is electrically connected to the second ECU 32, the hydraulic pump 30, a display unit 60 and a battery. The second ECU 32 is electrically connected to the engine 20 and the battery.

The hydraulic pump 30 is driven by the engine 20. The hydraulic motor 40 is constituted of a left-side hydraulic motor 140 and a right-side hydraulic motor 141, and is rotated by a pressurized oil (hydraulic oil) discharged from the hydraulic pump 30. Pressurized oil from the hydraulic pump 30 is supplied to or discharged from the left-side hydraulic motor 140 and the right-side hydraulic motor 141 respectively in response to control signals from a hydraulic pump control unit 23 (see FIG. 2). The left-side crawler 11a is driven by the left-side hydraulic motor 140, and the right-side crawler 11b is driven by the right-side hydraulic motor 141. That is, the left-side crawler 11a and the right-side crawler 11b are independently driven from each other. Although the description is made in this embodiment assuming a case where one hydraulic pump 30 is used, the working vehicle 10 may include two hydraulic pumps consisting of a hydraulic pump that corresponds to a left-side hydraulic motor and a hydraulic pump that corresponds to a right-side hydraulic motor.

On the respective left and right hydraulic motors 40, a first speed sensor (a rotational speed sensor) 24 that measures a rotational speed of the hydraulic motor 40, and a second speed sensor (a rotational speed sensor) 26 (see FIG. 2) that measures a rotational speed of the hydraulic motor 40 are mounted. Detected rotational speeds of the first speed sensor 24 and the second speed sensor 26 are transmitted to the first ECU 22. The first ECU 22 determines whether or not a traveling operation control described later is to be performed based on traveling speeds of the crawlers 11a, 11b based on rotational speeds detected by the first and second speed sensors 24, 26 and travel mode information from a traveling mode detection unit 28 described later. To be more specific, the first and second speed sensors 24, 26 detect respective rotational speeds of drive shafts (not illustrated in the drawing) that drive sprockets (not illustrated in the drawing) that constitute the traveling devices 12. The drive sprockets are gear-like parts, and transmit the rotation of the drive sprockets to the crawlers 11a, 11b. The respective traveling speeds of the left and right crawlers 11a, 11b are obtained based on the detected rotational speeds. Traveling speeds of the left and right crawlers 11a, 11b may be detected using positional information from other methods, for example, GPS (Global Positioning System). In this manner, the method of detecting the traveling speeds is not limited to the above-mentioned embodiment.

### [Operation Control System]

Hereinafter, with reference to FIG. 2 to FIG. 5(c), the description is made with respect to the working vehicle operation control system 1 that performs a traveling operation control based on the detection results from the first and second speed sensors 24, 26, the traveling mode detection unit 28, and the operating lever sensor 27. FIG. 2 is a block diagram illustrating the configuration of the working vehicle operation control system 1 according to the embodiment.

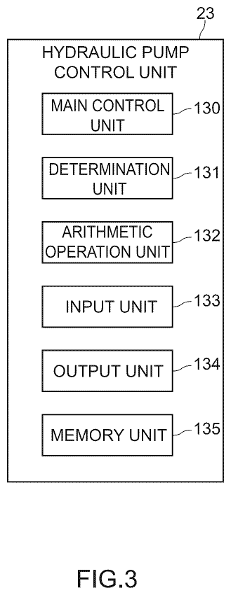

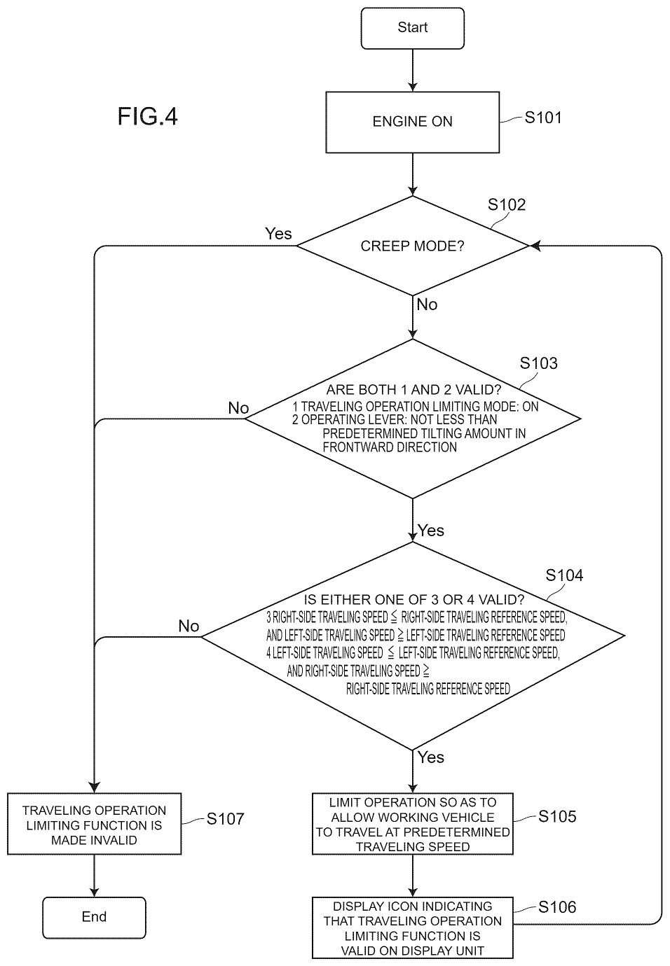

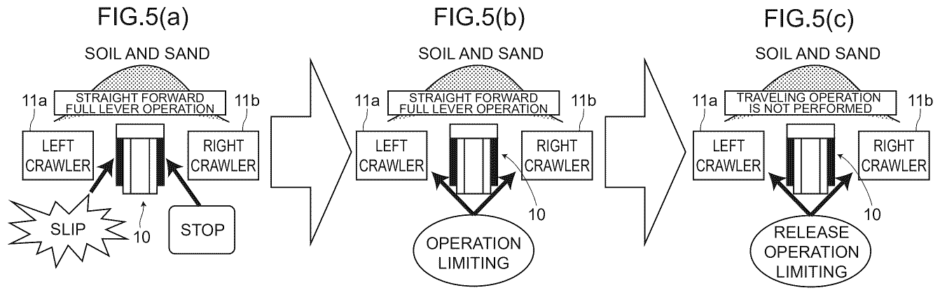

FIG. 3 is a block diagram illustrating the configuration of the hydraulic pump control unit 23. FIG. 4 is a flowchart illustrating working vehicle operation control processing performed by the hydraulic pump control unit 23. FIGS. 5(a) to 5(c) are a schematic view illustrating steps ranging from the detection of slipping to the release of traveling operation limiting processing. FIG. 5(a) is a view illustrating a state where a left crawler is slipped when a working vehicle travels straight forward and an operating lever is fully operated, FIG. 5(b) is a view illustrating a state where a traveling operation is limited, and FIG. 5(c) is a view illustrating a state where traveling operation limiting processing is released. In FIG. 1 to FIG. 5(c), constitutional elements substantially equal to the corresponding constitutional elements illustrated in FIG. 1 are given the same symbols.

The working vehicle operation control system 1 includes the first ECU 22, the first speed sensor 24, the second speed sensor 26, the traveling mode detection unit 28, the operating lever sensor 27, and the display unit 60. The first ECU 22 includes the hydraulic pump control unit 23. The first ECU 22 is, although not illustrated in the drawing, constituted of a microcomputer that includes central processing unit (CPU), a read only memory (ROM), a random access memory (RAM), input/output ports, and a communication port that are not illustrated in the drawings. As a signal inputted to the first ECU 22, for example, rotational speed information of drive shafts from the first speed sensor 24 and the second speed sensor 26, creep state information from the traveling mode detection unit 28 and the like are named. From the first ECU 22, various kinds of control signals are outputted via the output port. As a signal outputted from the first ECU 22, for example, control signals to a fuel injection valve (not illustrated in the drawings) of the engine 20 and the hydraulic pump 30 are named.

The first speed sensor 24 measures a rotational speed of the hydraulic motor 40 on a right side. The second speed sensor 26 measures a rotational speed of the hydraulic motor 40 on a left side. The traveling mode detection unit 28 detects whether or not traveling speeds of the crawlers 11a, 11b are set so as to allow the working vehicle 10 to travel in a creep mode where the traveling speed is lower than a low speed (for example, the traveling speed being not more than 1 km/h). To be more specific, the traveling mode detection unit 28 detects information on whether or not the traveling speed is in a creep mode instruction (whether or not the traveling mode is a creep mode) is issued by an operator. Information on whether or not the traveling mode is a creep mode is ON/OFF information of a creep mode setting instruction icon (a mode set/release button) displayed on the display unit 60. However, the information on whether or not the traveling mode is a creep mode is not limited to the ON/OFF information of a creep mode setting instruction icon.

The operating lever sensor 27 is an angle sensor mounted on an operating lever that can be tiltably operated in front, rear, left and right directions (not illustrated in the drawing, for example, a joystick or the like). For example, a potentiometer is named as the operating lever sensor 27. The operating lever sensor 27 detects whether or not the operation direction of the operating lever is within a range (180°) from a front side (meaning straight forward advancing direction) to left and right directions and whether or not a tilting amount exceeds a predetermined tilting amount based on a lever angle. For example, in a case where the predetermined tilting amount is set to a maximum tilting value (so-called full lever), when the operating lever is fallen to an upper limit in a frontward direction, it is determined that the operating lever is in a straight forward and full lever state. The detection method is not limited to such an operation provided that the above-mentioned operation can be detected.

The display unit 60 is a touch panel monitor, and functions as a user interface that allows inputting of information. The touch panel monitor includes a display panel and a touch panel. The display panel is a liquid crystal panel or an organic electro luminescence (EL) panel. Various graphic information, text information and the like are displayed on the display panel, or buttons are displayed on the display panel. The touch panel is disposed on the display panel in an overlapping manner, and a resistance type display panel and an electrostatic capacitance type display panel can be used.

The hydraulic pump control unit 23 includes a main control unit (a main controller) 130, a determination unit 131, an arithmetic operation unit 132, an input unit 133, an output unit 134, and a memory unit 135. The main control unit 130 receives a determination result from the determination unit 131 and an arithmetic operation result from the arithmetic operation unit 132, and generates and outputs a control signal for adjusting a pressurized oil amount of the hydraulic pump 30 as a controlled variable. By adjusting the pressurized oil amount, a rotational speed of the drive shaft is controlled and hence, a traveling speed is controlled. The determination unit 131 determines whether or not a discharge amount of the hydraulic pump 30 is to be restricted corresponding to the detection results of, for example, the first speed sensor 24, the second speed sensor 26, the operating lever sensor 27 and the traveling mode detection unit 28, and outputs the determination result. The arithmetic operation unit 132 calculates a present traveling speed based on the detection results from the first speed sensor 24 and the second speed sensor 26, or calculates a controlled variable (for example, the discharge amount of the hydraulic pump 30) corresponding to the determination results. To the input unit 133, the detection results from the first speed sensor 24, the second speed sensor 26 and the traveling mode detection unit 28 and information from a user via the display unit 60 are inputted. From the output unit 134, a control signal from the main control unit 130 is outputted to a controlled object (hydraulic pump 30 or the like). In the memory unit 135, a right-side traveling reference value, a left-side traveling reference value, a predetermined tilting amount and the like that are reference values (thresholds) in determinations (judgements) described later are stored.

The display unit 60 is disposed in the cabin 25 of the working vehicle 10 in front of the operator seat. On the display unit 60, for example, an icon that indicates whether or not the traveling mode is a creep mode and an icon that indicates whether or not an engine is turned on are displayed based on predetermined display control signals from the display control unit (not illustrated in the drawing).

### [Working Vehicle Operation Control Method]

Hereinafter, how a traveling control is performed under specific conditions is described with reference to a flowchart illustrated in FIG. 4. When the engine starts (ON) (step S101), in step S102, the determination unit 131 determines whether or not a present traveling mode is a creep mode based on a detection result from the traveling mode detection unit 28. When the determination unit 131 determines that the present traveling mode is not a creep mode, in step S103, the determination unit 131 determines the following determination items (1) and (2).

### (Determination Items)

(1) Determination on whether or not a traveling operation restricting mode is selected (ON)
(2) Determination on whether or not the operating lever is operated in a frontward direction with not less than a predetermined tilting amount

In these determinations, with respect to the determination item (1), it is determined valid in a case where the traveling operation restricting function button displayed on the display unit 60 is selected (ON), for example. The determination made whether or not the traveling operation restricting mode is selected is not limited to such processing. For example, it may be determined valid also in a case where a selection button that is capable of performing the ON/OFF of the traveling operation restricting mode is disposed at a place other than the display unit 60 and is turned ON.

With respect to the determination item (2), in a case where the operating lever is operated in a frontward direction with not less than a predetermined tilting amount, it is determined valid. The predetermined tilting amount means a tilting amount of the operating lever. The larger this value, the larger a control current value supplied from the first ECU 22 to the hydraulic pump becomes so that a traveling output is increased. When the output is small, the crawler is minimally brought into a slip state and hence, it is preferable to set the predetermined tilting amount of the operating lever to an amount close to the maximum value. For example, in a case where the operating lever is operated such that the operating lever is tilted forward (meaning straight advancing) and the predetermined tilting amount is maximum (meaning the full lever), it is determined valid.

In a case where it is determined valid in the above-mentioned both determination items (1) and (2) in step S103, for example, processing is shifted to step S104.

The determination unit 131 determines the following determination items (3) and (4) in step S104.

### (Determination Items)

(3) The determination unit 131 determines whether or not the right-side traveling speed (the traveling speed of the right-side crawler 11b) detected by the first speed sensor 24 is not more than the preset right-side traveling reference speed (for example, 1 km/h (ultra-low speed)) and determines whether or not the left-side traveling speed (the traveling speed of the left-side crawler 11a) detected by the speed sensor 26 is not less than the preset left-side traveling reference speed (for example, 2 km/h (low speed)). In a case where the above-mentioned conditions are satisfied, it is determined valid.

As the case where the above-mentioned condition is satisfied, as illustrated in FIG. 5(a), for example, a situation is estimated where the left-side crawler 11a slips and the right-side crawler 11b is stopped.
(4) The determination unit 131 determines whether or not the left-side traveling speed (the traveling speed of the left-side crawler 11a) detected by the second speed sensor 26 is not more than the preset left-side traveling reference speed (for example, 1 km/h (ultra-low speed)) and determines whether or not the right-side traveling speed (the traveling speed of the right-side crawler 11b) detected by the speed sensor 24 is not less than the preset right-side traveling reference speed (for example, 2 km/h (low speed)). In a case where the above-mentioned conditions are satisfied, it is determined valid.

As the case where the above-mentioned condition is satisfied, for example, a situation is estimated where the right-side crawler 11b slips and the left-side crawler 11a is stopped.

In step S104, when it is determined valid with respect to either one of the determination items (3) and (4), processing is shifted to step S105.

In a case where it is determined valid with respect to the above-mentioned determination item (3), the main control unit 130 controls the hydraulic pump 30 such that the pressurized oil discharge amount of the hydraulic pump 30 is decreased so that the left-side traveling speed becomes, for example, 1 km/h (see step S105: FIG. 5(b)) thus reducing the rotational speed of the hydraulic motor 40 on the left side. Although the right-side traveling reference speed is set to 1 km/h and the left-side traveling reference speed to 2 km/h in the determination item (3), the left-side traveling reference speed and the right-side traveling reference speed are not limited to these numerical values, and suitably set corresponding to an environment where the working vehicle 10 is used. Further, although the left-side traveling reference speed in the determination item (4) is set to 1 km/h and the right-side traveling reference speed in the determination item (4) is set to 2 km/h in the determination item (4), the right-side traveling reference speed and the left-side traveling reference speed are not limited to these numerical values, and are suitably set corresponding to an environment where the working vehicle 10 is used.

In a case where it is determined valid in the above-mentioned determination item (4), the main control unit 130 controls the hydraulic pump 30 such that a pressurized oil discharge amount of the hydraulic pump 30 is decreased so that a second right-side traveling speed becomes 1 km/h, for example (step S105), and hence, the rotational speed of the hydraulic motor 40 on the right side is decreased. Although the second left-side traveling reference speed is set to 1 km/h and the second right-side traveling reference speed is set to 2 km/h, the second left-side traveling reference speed and the second right-side traveling reference speed are not limited to these numerical values, and are suitably set corresponding to the use environment of the working vehicle 10. Further, although the example where the second right-side traveling speed is controlled to 1 km/h, for example, is exemplified, the second right-side traveling speed is not limited to such a numerical value, and is suitably set.

After the processing is shifted to traveling operation limiting in step S105, an icon that a traveling operation limiting function is valid is displayed on the display unit 60, and the processing returns to step S102. In a case where it is determined that the traveling mode is a creep mode in step S102 or in a case where the valid determination is not made in step S103 or step S104, the traveling operation limiting function is made invalid so that traveling operation limiting is released (see FIG. 5(c)).

In step S103, in a case where it is determined that at least one of the determination items (1) and (2) is not valid, the traveling operation limiting function is made invalid (step S107) and the processing is finished. This is because that, in a case of the creep mode, an ultra-low speed mode (lower than a low speed mode) is adopted and hence, it is not proper to set a traveling state into a traveling operation limiting state. In step S104, in a case where either one of the determination item (3) or the determination item (4) is not valid, processing is shifted to step S107. This is because that, in the case where either one of the determination item (3) or the determination item (4) is not valid, such a case is not a situation where one crawler slipped and the other crawler is stopped and hence, it is not proper to bring the traveling state into a traveling operation limiting state.

In the working vehicle operation control system 1 according to the embodiment, in a case where one of the left-side crawler traveling speed and the right-side crawler traveling speed of the crawlers 11a, 11b is not more than the predetermined traveling reference speed, and, at the same time, the other of the left-side crawler traveling speed and the right-side crawler traveling speed is not less than the predetermined traveling reference speed, a pressurized oil discharge amount of the hydraulic pump 30 is controlled so as to reduce the other crawler traveling speed. Accordingly, the traveling speed of the crawler in a slip state can be reduced to an ultra-low speed and hence, wear of the slipped crawler can be suppressed.

In the working vehicle operation control system 1 according to the embodiment, in a case where the right-side crawler traveling speed is not more than the right-side traveling reference speed and, at the same time, the left-side crawler traveling speed is not less than the left-side traveling reference speed that is larger than the right-side traveling reference speed, a pressurized oil discharge amount of the hydraulic pump 30 is controlled so as to reduce the left-side crawler traveling speed. Accordingly, it is possible to reduce a traveling speed of the left-side crawler 11a in a slip state to an ultra-low speed and hence, wear of the left-side crawler 11a can be suppressed.

In the working vehicle operation control system 1 according to the embodiment, in a case where the left-side crawler traveling speed is not more than the left-side traveling reference speed and, at the same time, the right-side crawler traveling speed is not less than the right-side traveling reference speed that is larger than the left-side traveling reference speed, a pressurized oil discharge amount of the hydraulic pump can be controlled so as to reduce the right-side crawler traveling speed. Accordingly, the traveling speed of the right-side crawler 11b in a slip state can be reduced to an ultra-low speed and hence, wear of the right-side crawler 11b can be suppressed.

The working vehicle operation control system 1 according to the embodiment detects the traveling speeds of the left and right crawlers in a state where the working vehicle is operated with not less than a predetermined tilting amount toward a front side, and determines whether or not either one of the left and right crawlers is in a slip state based on the detected traveling speeds of the left and right crawlers. Accordingly, in a case where the crawler in a slip state is identified, it is possible to reduce the traveling speed of the crawler in a slip state to an ultra-low speed (1 km/h) until a state where the operating lever is operated not less than the predetermined tilting amount frontward is released. Accordingly, the traveling processing can be shifted to the traveling operation limiting processing within a short time and hence, wear of the slipped crawler can be suppressed.

The present invention is not limited to the above-mentioned embodiment, and various modifications can be carried out without departing from the gist of the present invention.

1. A working vehicle operation control system for controlling a traveling operation of a working vehicle that includes: a hydraulic pump that is driven by an engine; and left and right hydraulic motors that drive left and right crawlers on left and right sides respectively independently by making use of a pressurized oil discharged from the hydraulic pump, wherein
the working vehicle operation control system includes a hydraulic pump control unit that controls a pressurized oil discharge amount of the hydraulic pump after the engine starts,
the hydraulic pump control unit is configured to control, in a case where one of a right-side crawler traveling speed and a left-side crawler traveling speed of the crawler is not more than a predetermined traveling reference speed and the other of the right-side crawler traveling speed and the left-side crawler traveling speed is not less than the predetermined traveling reference speed, the pressurized oil discharge amount of the hydraulic pump so as to decrease the other crawler traveling speed.

2. The working vehicle operation control system according to claim 1, wherein
the hydraulic pump control unit is configured to control the pressurized oil discharge amount of the hydraulic pump such that the left-side crawler traveling speed is decreased in a case where the right-side crawler traveling speed is not more than a predetermined right-side traveling reference speed, and in a case where the left-side crawler traveling speed is not less than a left-side traveling reference speed that is larger than the right-side traveling reference speed.

3. The working vehicle operation control system according to claim 1, wherein the hydraulic pump control unit is configured to control the pressurized oil discharge amount of the hydraulic pump such that the right-side crawler traveling speed is decreased in a case where the left-side crawler traveling speed is not more than a predetermined left-side traveling reference speed, and in a case where the right-side crawler traveling speed is not less than a right-side traveling reference speed that is larger than the left-side traveling reference speed.

4. The working vehicle operation control system according to claim 1 further comprising a display unit having an information inputting function, wherein
the hydraulic pump control unit is configured to determine whether or not a traveling operation restricting function is selected via the display unit, and to determine whether or not an operating lever is tilted at least frontward by not less than a predetermined tilting amount, and to control the pressurized oil discharge amount of the hydraulic pump so as to decrease a traveling speed of the crawler that is a traveling operation limiting object in a case where it is determined that the traveling operation limiting function is selected and that an operating lever is operated forward by not less than a predetermined tilting amount.
